(19) United States
(12) Patent Application Publication
(10) Pub. No.: US 2003/0118838 A1
(43) Pub. Date: Jun. 26, 2003

(54) Laminate, adhering method and active energy ray-curable composition

(75) Inventors: Kazuyuki Hata, Yokkaichi-shi (JP); Katsuhiko Yamada, Yokkaichi-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: MITSUBISHI CHEMICAL CORPORATION, Tokyo (JP)

(21) Appl. No.: 10/262,898

(22) Filed: Oct. 3, 2002

Related U.S. Application Data
(63) Continuation of application No. PCT/JP01/02863, filed on Apr. 2, 2001.

(30) Foreign Application Priority Data
Apr. 3, 2000 (JP) P. 2000-100186
May 25, 2000 (JP) P. 2000-154117

(51) Int. Cl. B32B 31/00; B32B 27/00

(52) U.S. Cl. 428/424.2; 156/272.2

(57) ABSTRACT

The invention provides an active energy ray-curable composition which can be prepared from easily available raw materials, which has excellent coating properties, and which forms, when cured, a coat having a good adhesion to a polyolefin, and a method for forming the coat using the composition.

That is, the invention is an active energy ray-curable composition containing a reaction product between an isocyanate compound having an isocyanate group bound to a non-aromatic hydrocarbon ring and a (meth)acryl compound having a (meth)acryloyl group and being capable of reacting with an isocyanate group, and a method for forming a coat using the composition.

### TECHNICAL FIELD

This invention relates to an active energy ray-curable composition, particularly to a composition capable of forming a coat with a good adhesion when applied to polyolefin such as polypropylene, and to a laminate and an adhering method based on the composition.

Additionally, in this specification, the term “(meth)acryloyl group” means an acryloyl group and/or a methacryloyl group, the term “(meth)acryl compounds” means acryl compounds and/or methacryl compounds, the term “(meth)acrylates” means acrylates and/or methacrylate, and the term “(meth)acrylic acid” means acrylic acid and/or methacrylic acid.

### BACKGROUND ART

Polyolefins have excellent chemical properties and are light-weight and inexpensive, and hence they are being used in a large amount in various fields. One of the problems with the polyolefins is that, since they are non-polar and poor in adhesion with other materials, they show poor adhesive properties when subjected to printing or coating. In particular, in order to form a coat with good adhesive properties on the polyolefin using an active energy ray-curable composition which contracts upon curing, it is believed to be necessary to improve adhesion of the polyolefins themselves by previously subjecting them to corona discharge treatment or the like.

Since it is troublesome to previously improve adhesion of the polyolefins by the corona discharge treatment or the like, there have conventionally been proposed several active energy ray-curable compositions which provide a coat having a good adhesion to polyolefins without such treatment. For example, Japanese Patent Laid-Open No. 279706/1994 describes that an excellent undercoat layer for deposition can be formed by coating a composition containing a chlorinated polyolefin, a (meth)acryloyloxy group-having compound and an acrylic copolymer on a polyolefin, then curing the coated composition. Japanese Patent Laid-Open No. 237288/1998 describes that a coat with a good adhesion can be formed by coating a composition containing a polyester resin obtained by reacting a dibasic anhydride obtained by conducting Diels-Alder reaction between an adduct of cyclopentadiene and allyl chloride and maleic anhydride with an alcohol obtained by adding allyl alcohol to a cyclopentadiene polymer, and an ethylenically unsaturated compound on a polyolefin, then curing the coated composition. Japanese Patent Laid-Open No. 310621/1998 describes that a coat with a good adhesion can be formed by coating a composition containing epoxy (meth)acrylate, dicyclopentenyl (meth)acrylate and tricyclodecanyl (meth)acrylate on polypropylene or the like, then curing the coated composition.

As is described above, there have been proposed several compositions which can form a coat with a good adhesion to polyolefins when cured by irradiation with active energy rays. However, none of them are satisfactory. Thus, the invention intends to provide an active energy ray-curable composition which can be prepared from easily available materials, which shows good coating properties, and which can form a coat with a good adhesion to polyolefins when cured.

### DISCLOSURE OF THE INVENTION

The inventors have found that, in an active energy ray-curable composition containing a reaction product between an isocyanate compound and a (meth)acryl compound having a (meth)acryloyl group and being capable of reacting with an isocyanate group, the use of an isocyanate compound having an isocnanate group bound to a non-aromatic hydrocarbon ring as the isocyanate compound serves to markedly improve adhesion of the resultant active energy ray-curable composition to polyolefins, thus having achieved the invention. That is, the gist of the invention lies in the following.

1. A laminate containing a polyolefin substrate having formed thereon a layer containing an active energy ray-curable composition which contains a reaction product between an isocyanate compound having an isocyanate group bound to a non-aromatic hydrocarbon ring and a (meth)acryl compound having a (meth)acryloyl group and being capable of reacting with the isocyanate group.

2. A method of adhering polyolefin, which contains using an active energy ray-curable composition which contains a reaction product between an isocyanate compound having an isocyanate group bound to a non-aromatic hydrocarbon ring and a (meth)acryl compound having a (meth)acryloyl group and being capable of reacting with the isocyanate group.

3. A process for producing a substrate with a coat, which contains forming on the substrate a coat layer containing an active energy ray-curable composition containing a reaction product between an isocyanate compound having a melting point of 40° C. or higher and a (meth)acryl compound having a (meth)acryloyl group and being capable of reacting with the isocyanate group, which product has a softening point of 40° C. or higher, conducting fabrication, then curing the active energy ray-curable composition.

4. A laminate containing a substrate having formed thereon a layer containing an active energy ray-curable composition containing a reaction product between an isocyanate compound having a melting point of 40° C. or higher and a (meth)acryl compound having a (meth)acryloyl group and being capable of reacting with the isocyanate group, which product has a softening point of 40° C. or higher.

5. An active energy ray-curable composition, which contains a reaction product between an isocyanate compound having an isocyanate group bound to a non-aromatic hydrocarbon ring and a (meth)acryl compound having a (meth)acryloyl group and being capable of reacting with the isocyanate group.

### BEST MODE FOR CARRYING OUT THE INVENTION

Isocyanate Compounds having an Isocyanate Group Bound to a Non-aromatic Hydrocarbon Ring

The isocyanate compounds to be used in the invention which have an isocyanate group bound to a non-aromatic hydrocarbon ring (hereinafter also referred to merely as “isocyanate compounds”) are so-called alicyclic isocyanate compounds or the derivatives thereof. As the alicyclic isocyanate compounds, isophoronediisocyanate, hydrogenated tolylenediisocyanate, hydrogenated xylylenediisocyanate, hydrogenated diphenylmethane-diisocyanate, etc. may be commonly used. Of these, isophoronediisocyanate is preferably used.

As the derivatives of the alicyclic isocyante compounds, there are commonly used trimers of alicyclic isocyanate wherein the alicyclic isocyanate compound is trimerized so as to form an isocyanurate ring, a reaction product between an alicyclic isocyanate compound and an active hydrogen-containing compound, and a reaction product between an alicyclic isocyanate trimer and an active hydrogen-containing compound. Preferably, isophorone diisocyanate trimer and a reaction product between isophorone diisocyanate and trimethylolpropane are used. These are commercially sold as VESTANAT T1890 (made by Huls Co.), Mitec NY215A (Mitsubishi Chemical Corporation), and are easily available from the market.

As the alicyclic isocyanate compounds and the derivatives thereof, those are preferably used which have a melting point of 40° C. or higher. A UV ray-curable composition obtained by using the alicyclic isocyanate compound and the derivative thereof having a melting point of 40° C. or higher does not form a fingermark when touched on its dried coat surface on the substrate with a finger (tack-free), thus fabrication after forming the coat film being conducted with ease. Examples of the alicyclic isocyanate compound and the derivative thereof having a melting point of 40° C. or higher include isophoronediisocyanate trimer (110° C.) and a reaction product between isophorone diisocyanate and trimethylolpropane (3:1 in molar ratio) (mp 67° C.)

As the active hydrogen-containing compounds to be reacted with the isocyanate compounds, there may commonly be used hydroxyl group-containing compounds, amino group-containing compounds, carboxyl group-containing compounds, etc. In particular, hydroxyl group-containing compounds are preferably used.

As the hydroxyl group-containing compounds, there are used polyhydric alcohols having three or more hydroxyl groups such as glycerin, trimethylolpropane, trimethylolethane, 1,2,6-hexanetriol, 2-hydroxyethyl-1,6-hexanediol, 1,2,4-butanetriol, erythritol, sorbitol, pentaerythritol and dipentaerythritol; aliphatic glycols such as ethylene glycol, diethylene glycol, propylene glycol, dipropylene glycol, tripropylene glycol, 1,2-butanediol, 1,3-butanediol, 1,4-butanediol, 2,3-butanediol, 2-methyl-1,3-propanediol, 2,2-diethyl-1,3-propanediol, 2-methyl-2-propyl-1,3-propanediol, 2-butyl-2-ethyl-1,3-propanediol, 1,5-pentanediol, 3-methyl-1,5-pentanediol, 2-methyl-2,4-pentanediol, 1,6-hexanediol, 2-ethyl-1,3-hexanediol, neopentyl glycol, 1,3,5-trimethyl-1,3-pentanediol, 2,2,4-trimethyl-1,3-pentanediol, 1,8-octanediol, 1,9-nonanediol and 2-methyl-1,8-octanediol; alicyclic glycols such as 1,4-cyclohexanediol and 1,4-cyclopexanedimethanol; aromatic glycols such as xylylene glycol and bishydroxyethoxybenzene; etc.

Also, as the hydroxyl group-containing compounds, there may be used high molecular weight polymers such as polyether polyols, polyester polyols, polyether ester polyols polycarbonate polyols and polyacryl polyols.

Examples of the polyether polyols include those which are obtained by addition polymerization of an alkylene oxide such as ethylene oxide or propylene oxide to glycols such as bisphenol A, ethylene glycol, propylene glycol and diethylene glycol, to polyols having 3 or more hydroxyl groups such as glycerin, trimethylolethane, trimethylolpropane and pentaerythritol, or to polyamines such as ethylenediamine and toluenediamine; and polytetramethylene ether glycols obtained by ring-opening polymerization of tetrahydrofuran.

Examples of the polyester polyols include those which are obtained by polycondensation reaction between carboxylic acids such as dicarboxylic acids exemplified by succinic acid, adipic acid, sebacic acid, azelaic acid and phthalic acid or tri- or tetra-carboxylic acids exemplified by trimellitic acid and pyromellitic acid and diols such as ethylene glycol, propylene glycol, 1,4-butanediol, 1,5-pentanediol, 3-methyl-1,5-pentanediol, 2,2-diethylpropanediol, 2-ethyl-2-butylpropanediol, 1,6-hexanediol, neopentylglycol, diethylene glycol, 1,4-cyclohexanediol and 1,4-cyclohexanedimethanol, triols such as trimethylolpropane and glycerin or aromatic polyhydroxy compounds such as bisphenol A and bisphenol F.

Examples of the polyether ester polyols include a reaction product between polyester glycol and alkylene oxide, and a reaction product between an ether group-containing diol or a mixture thereof with other glycol and the aforesaid dicarboxylic acid or the anhydride thereof, such as poly(polytetramethylene ether) adipate.

Examples of the polycarbonate polyols include those polycarbonate polyols which are obtained by alcohol-eliminating condensation reaction between a polyhydric alcohol and a dialkyl carbonate such as dimethyl or diethyl carbonate, phenol-eliminating condensation reaction between a polyhydric alcohol and diphenylcarbonate, and ethylene glycol-eliminating condensation reaction between a polyhydric alcohol and ethylene carbonate. Examples of the polyhydric alcohol to be used in these condensation reactions include, for example, aliphatic diols such as 1,6-hexanediol, diethylene glycol, propylene glycol, 1,4-butanediol, 1,5-pentanediol, 3-methyl-1,5-pentanediol, 2,2-diethylpropanediol, 2-ethyl-2-butylpropanediol and neopentyl glycol; and alicyclic diols such as 1,4-cyclohexanediol and 1,4-cyclohexanedimethanol.

Examples of the amino group-containing compounds include hexamethylenediamine, xylenediamine, isophoronediamine and N,N-dimethylethylenediamine. Also, aminoalcohols such as monoethanolamine and diethanolamine can be used as the active hydrogen-containing compounds.

The reaction between the alicyclic isocyanate compound or its trimer and the active hydrogen-containing compound is usually conducted at a temperature of 10° C. to 90° C. Although the reaction proceeds in the absence of a catalyst, there may be used organic tin catalysts such as dibutyltin dilaurate and dibutyltin dioctoate, organic lead catalysts such as lead octanoate or tertiary amine compounds such as triethylamine, dimethyloctylamine and diazabicycloundecene. Use of the catalyst serves to complete the reaction in a shorter time. Progress of the reaction can be monitored by measuring the content of isocyanate group. The reaction system is cooled at a point when the content of isocyanate group reaches an intended level to thereby quench the reaction.

The reaction may be conducted in the absence or presence of a solvent. In general, use of a solvent facilicates to control the reaction and permits to adjust viscosity of a resultant reaction solution. As the solvent, there may be used those inert solvents which are commonly used for this type of reactions, such as aromatic hydrocarbon solvents (e.g., toluene, xylene, etc.), ketone solvents (e.g., methyl ethyl ketone, methyl isobutyl ketone, cyclohexanone, etc.), ester solvents (e.g., ethyl acetate, butyl acetate, isobutyl acetate, etc.), glycol ether ester solvents (e.g., diethylene glycol ethyl ether acetate, propylene glycol methyl ether acetate, 3-methyl-3-methoxybutyl acetate, ethyl-3-ethoxypropionate, etc.), ether solvents (e.g., tetrahydrofuran, dioxane, etc.), and aprotic polar solvents (e.g., N-methylpyrrolidone, etc.).

(Meth)acryl Compounds having a (meth)acryloyl Group and being Capable of Reacting with Isocyanate Group

As the (meth)acryl compounds having a (meth)acryloyl group and being capable of reacting with isocyanate group (hereinafter sometimes abbreviated as “(meth)acryl compounds”), there are illustrated (meth)acrylic acid itself, hydroxy esters which are hydroxyl group-containing reaction products between (meth)acrylic acid and a polyhydroxy compound and, further, compounds obtained by adding ethylene oxide, propylene oxide, caprolactone, etc. to the hydroxyl group of the hydroxy esters and compounds obtained by reacting a polycarboxylic acid anhydride with the hydroxyl group of the hydroxy esters to thereby convert the hydroxyl group functioning as the active hydrogen group to carboxyl group.

Specifically, there are illustrated hydroxy (meth)acrylates such as hydroxyethyl (meth)acrylate, hydroxypropyl (meth)acrylate, hydroxybutyl (meth)acrylate, trimethylolpropane diacrylate, pentaerythritol triacrylate, dipentaerythritol tetraacrylate, dipentaerythritol pentaacrylate, etc.; and caprolactone adducts thereof, ethylene oxide adducts thereof, propylene oxide adducts thereof, ethylene oxide propylene oxide adducts thereof, etc. In addition, there are illustrated reaction products obtained by reacting the above-described hydroxy (meth)acrylates with a carboxylic acid anahydride (e.g., maleic anhydride, succinic anhydride, phthalic anhydride or tetrahydrophthalic anhydride), such as pentaerythritol triacrylate succinic acid monoester, dipentaerythritol pentaacrylate succinic acid monoester, pentaerythritol triacrylate maleic acid monoester, dipentaerythritol pentaacrylate maleic acid monoester, pentaerythritol triacrylate phthalic acid monoester, dipentaerythritol triacrylate phthalic acid monoester, pentaerythritol triacrylate tetrahydrophthalic acid monoester, dipentaerrythritol pentaacrylate tetrahydrophthalic acid monoester, etc.

Of these, there are used preferably hydroxy (meth)acrylates, particularly preferably reaction products between pentaerythritols and (meth)acrylic acid (e.g., pentaerythritol monoacrylate, pentaerythritol diacrylate and pentaerythritol triacrylate), still more preferably compounds having 2 or more (meth)acryloyl groups per molecule, most preferably pentaerythritol triacrylate.

Reaction Products between an Isocyanate Compound and a (meth)acryl Compound

The reaction between an isocyanate compound and a (meth)acryl compound can be conducted in the same manner as with the aforesaid reaction between the alicyclic isocyanate compound or the trimer thereof and the active hydrogen-containing compound. Preferably, the reaction is conducted by adjusting the concentration of a reaction product in the reaction solution to 30 to 80% by weight using a solvent and conducting the reaction at a temperature of 50 to 80° C. in the presence of an organic tin catalyst in an amount of 0.01 to 0.1% by weight based on the raw materials for the reaction. As to the ratio of the isocyanate compound to the (meth)acryl compounds to be charged, it is preferred to use the (meth)acryl compound to be reacted to the isocyanate compound in an amount of 0.5 mol or more in terms of its functional group, particularly preferably 1 mol or more, per mol of isocyanate group of the isocyanate compound. The reaction time is usually about 3 to 8 hours, but it is preferred to trance the content of isocyanate group in the reaction solution by analysis and discontinue the reaction at a point when the content reaches the intended level.

The thus obtained reaction product between the isocyanate compound and the (meth)acryl compound has a softening point of preferably 40° C. or more. In case when the softening point does not reach 40° C., it becomes difficult to form a coat with no tack and no fluidity by coating a UV ray-curable composition containing the resultant reaction product on a substrate and drying it. Additionally, the softening point is measured on a sample prepared by removing the solvent from the above-described reaction product, in the following manner.

Measurement of Softening Point

Apparatus used: ARES-2KFRTNI manufactured by Rheometrix Co. Measuring conditions:

Measuring mode: test on temperature dependence of dynamic viscoelasticity; 25 mm parallel plate

Range of measuring temperature: −50 to 90° C.

Vibration frequency: 1 rad/sec

In the case of measuring using the above-described apparatus under the above-described conditions, the temperature at which melt viscosity becomes 5000 Pa·s is defined as the softening point.

The active energy ray-curable composition of the invention may contain, in addition to the reaction product between the above-described isocyanate compound and the (meth)acryl compound, those which are commonly used for curable compositions such as a filming resin, a reactive monomer, a photopolymerization initiator, a polymerization inhibitor, a colorant, a surfactant, a solvent, etc.

In the active energy ray-curable composition of the invention, the content of the reaction product between the isocyanate compound and the (meth)acryl compound is usually 10% by weight or more, preferably 30% by weight or more, based on the weight of the active energy ray-curable composition excluding the solvent. In case when the proportion of the reaction product between the isocyanate compound and the (meth)acryl compound is too little, there results an insufficient adhesion to a substrate, particularly polypropylene.

Usually, a sufficient adhesion to a substrate can be obtained by the above-described reaction product alone but, in the case where it is difficult to form a coat, adhesion to the substrate can be improved by incorporating a filming resin. As such filming resin, there may be used methacrylic resins, chlorinated polypropylene, epoxy resins, polyurethane resins or polyester resins. Preferably, a methacrylic resin or chlorinated polypropylene is used, with a methacrylic resin containing methyl methacrylate as a major component being particularly preferably used. The content of the filming resin is usually 20 to 40% by weight based on the weight of the composition excluding the solvent.

As the reactive monomer, there may be used methyl (meth)acrylate, ethyl (meth)acrylate, propyl (meth) acrylate, butyl (meth)acrylate, 2-ethylhexyl (meth)acrylate, stearyl (meth)acrylate, lauryl (meth)acrylate, tridecyl (meth)acrylate, trimethylolpropane triacrylate, tris(acryloxyethyl)-isocyanurate, pentaerythritol tetraacrylate, dipentaerythritol hexaacrylate, etc. Hardness or durability of a resultant coat can be improved by incorporating the reactive monomer. The content of the reactive monomer is usually 80% by weight or less, preferably 50% by weight or less based on the weight of the composition excluding the solvent. In case when the proportion of the reactive monomer is too little, the intended purposes might not be attained whereas, in case when the proportion is too much, there might result a reduced adhesion to a substrate.

As the photopolymerization initiator, there may be used benzoin ethyl ether, acetophenone, diethoxyacetophenone, benzyl dimethyl ketal, 2-hydroxy-2-methylpropiophenone, 1-hydroxycyclohexyl phenyl ketone, benzophenone, p-chlorobenzophenone, Michler's ketone, isoamyl N,N-dimethylaminobenzoate, 2-chlorothioxanthone, 2,4-diethylthioxanthone, etc. The amount of the photopolymerization initiator is usually 0.1 to 15% by weight, preferably 1 to 5% by weight, per 100% by weight of the components of the composition except for solvents. In case when the proportion of the photopolymerization initiator is too little, photocurability tends to be insufficient whereas, too much, there tends to result a cured products with deteriorated properties such as hardness.

As the solvent, so-called inert solvents as illustrated in the description with respect to the reaction between the isocyanate compound and the active hydrogen-containing compound may be used.

In the case of using a solvent in the reaction between the isocyanate compound and the (meth)acryl compound, the reaction product between the isocyanate compound and the (meth)acryl compound is obtained in a state of the reaction product being dissolved in the solvent. Hence, it can be used as such, or in a concentrated state, as a raw material for the active energy ray-curable composition of the invention, in which the reaction product between the isocyanate compound and the (meth)acryl compound is in a state of being dissolved in the solvent.

The amount of the solvent is usually 10 to 80% by weight, preferably 30 to 70% by weight, in the composition. In case when the proportion of the solvent is too little, there tends to result a high viscosity and poor coating properties whereas, too much, there might result a composition with such a low viscosity that sag of the active energy ray-curable composition occurs upon coating or that it takes a long time to dry or cure the composition.

The active energy ray-curable composition of the invention can form a coat with a good adhesion on various substrates such as plastics (e.g., polyolefin, polyester, polycarbonate and (meth)acrylic resin) , paper and metals. In particular, it can form a coat with a good adhesion on polyolefin with which it is generally believed to be difficult to form a coat with a good adhesion thereon. Since the active energy ray-curable composition of the invention shows a good adhesion to a substrate, a sufficient adhesion force can be obtained even without previous surface treatment such as corona discharge treatment, plasma treatment or acid treatment of the substrate surface to be coated therewith. It is also possible to adhere these substrates to other materials by using this composition therebetween. Specific examples of the polyolefins to be used as substrates include α-olefin (co)polymers such as polyethylene, polypropylene, polybutene-1, ethylene-propylene copolymer, ethylene-butene copolymer, ethylene-propylene-diene copolymer and isobutene-isoprene copolymer; copolymers between α-olefin and a conjugated diene; and various copolymers between α-olefin and other vinyl monomer such as vinyl ester (e.g., vinyl acetate), (meth)acrylic acid, (meth)acrylic acid ester, maleic anhydride, styrene or vinylsilane (e.g., vinyltrimethoxysilane, γ-(meth)acryloyloxypropyltri-methoxysilane.

The active energy ray-curable composition of the invention may be used as an ink, a paint, an adhesive or an anchor coat for deposition utilizing the adhesion properties to substrates.

In the case of using the active energy ray-curable composition of the invention as an ink, it suffices to print an ink containing the composition on a substrate according to off-set printing, gravure printing, screen printing, relief printing, heat-sensitive transfer process, melt transfer process, sublimation heat-sensitive transfer process or ink jet process and, after drying the ink, irradiate it with active energy rays to cure.

In the case of using as a paint, an anchor coat material for deposition or a surface-protecting material, it suffices to coat the composition on a substrate using a bar coater, a spin coater, a knife coater, gravure coater or a roll coater and, after drying the composition, irradiate it with active energy rays to cure. For example, in the case of forming a coat of the active energy ray-curable composition of the invention on the surface of a substrate as a surface-protecting material for improving abrasion resistance of the substrate, it suffices to coat the composition on the substrate in a dry thickness of usually 1 to 15 μm, preferably 3 to 15 μm, and, after drying it, irradiate it with active energy rays, preferably UV rays to cure.

As is described above, when the active energy ray-curable composition of the invention is used as an ink, a paint, an adhesive or a surface-protecting agent, there results a laminate wherein the layer of the active energy-curable composition of the invention is formed on the substrate. In this case, the shape of substrate is not particularly limited. Also, the layer thickness of the active energy ray-curable composition is usually 0.1 to 200 μm, preferably 1 to 100 μm. In particular, in the case of using as an ink or a paint, the thickness is usually 1 to 100 μm, preferably 5 to 50 μm and, in the case of using as an anchor coat material, the thickness is usually 1 to 50 μm, preferably 2 to 10 μm.

Examples of the active energy rays to be used for curing the active energy ray-curable composition of the invention include UV rays, electron beams, radiation, etc., with UV rays being preferably used. As a light source of UV rays, there may usually be used a xenon lamp, a low-pressure mercury lamp, a high-pressure mercury lamp, a metal halide lamp, a carbon arc lamp or a tungsten lamp.

In addition, the active energy ray-curable composition obtained by using, among the reaction products between the isocyanate compound and the (meth)acryl compound, the reaction product having a softening point of 40° C. or higher loses its fluidity upon being dried, and hence it can preferably be used as an ink for multi-color printing utilizing the fluidity-losing properties. That is, in the case of conducting multi-color printing using inks containing the composition, because the inks do not run mutually to form no mixed color, all colors may be printed, followed by curing the printed surface at the same time in place of curing the printed surface every time printing a particular color, thus the steps being made simplified.

Similarly, utilizing the properties of losing fluidity upon being dried, the resulting product can be used as a substrate for accurate emboss processing. That is, when a coat formed by coating the active energy ray-curable composition of the invention on a substrate and drying it is subjected to emboss processing, a metal mold is not stained since the coat does not adhere to the metal mold and, owing to no fluidity of the coat, the shape formed by the emboss processing can be kept well until curing.

Further, the active energy ray-curable composition containing the reaction product between the isocyanate compound having a melting point of 40° C. or higher and the (meth)acryl compound having a (meth)acryloyl group and being capable of reacting with an isocyanate group, which product has a softening point of 40° C. or higher shows a more remarkable effect of losing its fluidity upon being dried. In the case of coating this composition on a substrate, the dried coated film shows such a low tackiness that, even when touched with a finger, no finger prints remain, and hence various fabrications such as sputtering can be conducted with ease before curing the coated film by irradiation with active energy rays. In this case, substrates to be used are not particularly limited but, preferably, polyesters such as polyethylene terephthalate and polybutylene terephthalate are used.

The isocyanate compound having a melting point of 40° C. or higher is a compound having a melting point of 40° C. or higher and having at least one isocyanate group. For example, there may be used tolylenediisocyanate trimer (mp: 110° C.); and a reaction product between tolylenediisocyanate and an active hydrogen-containing compound such as a reaction product between tolylenediisocyanate and trimethylolpropane (3:1 in molar ratio) (mp: 43° C.). Preferably, there are illustrated the aforesaid compounds having an isocyanate group bound to a non-aromatic hydrocarbon ring, more preferably alicyclic isocyanate compounds and the derivatives thereof, particularly preferably isophoronediisocyanate trimer (mp: 110° C.) and a reaction product between isophoronediisocyanate and trimethylolpropane (3:1 in molar ratio) (mp: 67° C.). When the isocyanate compound used has a melting point of lower than 40° C., it is difficult to form a tack-free coat.

### EXAMPLES

The invention is more specifically described below by reference to Examples which, however, do not limit the invention in any way.

Synthesis of Reaction Product (A)

206.1 g of ethyl acetate and 133.5 g of isophoronediisocyanate trimer [VESTANAT T1890(manufactured by HULS Co.); mp: 110° C.] were charged in a reactor equipped with a stirrer, a reflux condenser, a dropping funnel and a thermometer, and the temperature within the system was raised to 80° C. to dissolve. Subsequently, air was introduced into the solution, and 0.38 g of hydroquinone monomethyl ether, 249.3 g of pentaerythritol triacrylate [Viscoat 300 (made by Osaka Organic Chemical Industry Co., Ltd.)] and 0.38 g of dibutyltin dilaurate were charged therein, followed by conducting the reaction at the same temperature for 5 hours. After completion of the reaction, 688.9 g of ethyl acetate was added thereto to cool the reaction mixture and obtain a reaction product solution containing a reaction product (A). Analysis of infrared absorption spectrum of the reaction product solution confirmed disappearance of absorption of isocyanate group. A product obtained by distilling off ethyl acetate from the reaction product solution had a softening temperature of 43° C.

Synthesis of Reaction Product (B)

198.5 g of ethyl acetate and 308.3 g of isophoronediisocyanate trimer [VESTANAT T1890; mp: 110° C.] were charged in a reactor equipped with a stirrer, a reflux condenser, a dropping funnel and a thermometer, and the temperature within the system was raised to 80° C. to dissolve. Subsequently, air was introduced into the solution, and 0.33 g of hydroquinone monomethyl ether, 154.9 g of hydroxyethyl acrylate and 0.33 g of dibutyltin dilaurate were added thereto, followed by conducting the reaction at the same temperature for 8 hours. Further, 0.33 g of dibutyltin dilaurate was added thereto, followed by conducting the reaction at the same temperature for 8 hours. After completion of the reaction, 884.6 g of ethyl acetate was added thereto to cool the reaction mixture and obtain a reaction product solution containing a reaction product (B). Analysis of infrared absorption spectrum of the reaction product solution confirmed disappearance of absorption of isocyanate group.

Synthesis of Reaction Product (C)

118.2 g of ethyl acetate and 169.9 g of isophoronediisocyanate trimer [VESTANAT T1890; mp: 110° C.] were charged in a reactor equipped with a stirrer, a reflux condenser, a dropping funnel and a thermometer, and the temperature within the system was raised to 80° C. to dissolve. Subsequently, air was introduced into the solution, and 0.20 g of hydroquinone monomethyl ether, 106.0 g of hydroxybutyl acrylate and 0.20 g of dibutyltin dilaurate were charged therein, followed by conducting the reaction at the same temperature for 5 hours. After completion of the reaction, 526.5 g of ethyl acetate was added thereto to cool the reaction mixture and obtain a reaction product solution containing a reaction product (C). Analysis of infrared absorption spectrum of the reaction product solution confirmed disappearance of absorption of isocyanate group. A product obtained by distilling off ethyl acetate from the reaction product solution had a softening temperature of 72° C.

Synthesis of Reaction Product (D)

124.5 g of ethyl acetate and 145.7 g of isophoronediisocyanate trimer [VESTANAT T1890; mp: 110° C.] were charged in a reactor equipped with a stirrer, a reflux condenser, a dropping funnel and a thermometer, and the temperature within the system was raised to 80° C. to dissolve. Subsequently, air was introduced into the solution, and 0.21 g of hydroquinone monomethyl ether, 144.9 g of caprolactone-modified acrylate [Praccel FA1DT (made by Daicel Kagaku Kogyo K. K.) and 0.21 g of dibutyltin dilaurate were charged therein, followed by conducting the reaction at the same temperature for 5 hours. After completion of the reaction, 554.5 g of ethyl acetate was added thereto to cool the reaction mixture and obtain a reaction product solution containing a reaction product (D). Analysis of infrared absorption spectrum of the reaction product solution confirmed disappearance of absorption of isocyanate group.

Synthesis of Reaction Product (E)

95.5 g of ethyl acetate and 169.9 g of isophoronediisocyanate trimer [VESTANAT T1890; mp: 110° C.] were charged in a reactor equipped with a stirrer, a reflux condenser, a dropping funnel and a thermometer, and the temperature within the system was raised to 80° C. to dissolve. Subsequently, air was introduced into the solution, and 0.16 g of hydroquinone monomethyl ether, 53.0 g of acrylic acid and 0.16 g of dibutyltin dilaurate were charged therein, followed by conducting the reaction at the same temperature for 8 hours. After completion of the reaction, 425.3 g of ethyl acetate was added thereto to cool the reaction mixture and obtain a reaction product solution containing a reaction product (E) . Analysis of infrared absorption spectrum of the reaction product solution confirmed disappearance of absorption of isocyanate group.

Synthesis of Reaction Product (F)

455.4 g of pentaerythritol triacrylate [Viscoat 300], 133.5 g of isophoronediisocyanate trimer [VESTANAT T1890; mp: 110° C.] and 0.38 g of hydroquinone monomethyl ether were charged in a reactor equipped with a stirrer, a reflux condenser, a dropping funnel and a thermometer and, while introducing thereinto air, the temperature within the system was raised to 80° C. to dissolve. Subsequently, 0.38 g of dibutyltin dilaurate was charged therein, followed by conducting the reaction at the same temperature for 5 hours. After completion of the reaction, the reaction mixture was cooled to obtain a reaction product solution containing a reaction product (F). Analysis of infrared absorption spectrum of the reaction product solution confirmed disappearance of absorption of isocyanate group.

Synthesis of Reaction Product (G)

82.0 g of ethyl acetate and 148.0 g of a reaction product between isophoronediisocyanate and trimethylolpropane [Mitec NY215A (made by Mitsubishi Chemical Corporation; solid content: 75% by weight; mp of the solid component: 67° C.) were charged in a reactor equipped with a stirrer, a reflux condenser, a dropping funnel and a thermometer, and the temperature within the system was raised to 80° C. Subsequently, air was introduced into the solution, and 0.20 g of hydroquinone monomethyl ether, 167.7 g of pentaerythritol triacrylate [Viscoat 300] and 0.20 g of dibutyltin dilaurate were charged therein, followed by conducting the reaction at the same temperature for 5 hours. After completion of the reaction, 531.6 g of ethyl acetate was added thereto to cool the reaction mixture and obtain a reaction product solution containing a reaction product (G). Analysis of infrared absorption spectrum of the resultant reaction product solution confirmed disappearance of absorption of isocyanate group. The product obtained by distilling off ethyl acetate from the reaction product solution had a softening temperature of 41° C.

Synthesis of Reaction Product (H)

142.7 g of ethyl acetate and 169.9 g of isophoronediisocyanate trimer [VESTANAT T1890] were charged in a reactor, and the temperature within the system was raised to 80° C. to dissolve. After bubbling air into the solution, 0.20 g of hydroquinone monomethyl ether, 163.2 g of 2-hydroxy-3-phenoxypropyl acrylate and 0.20 g of dibutyltin dilaurate were charged therein. After conducting the reaction at 80° C. for 5 hours, 635.6 g of ethyl acetate was added thereto to cool the reaction mixture and obtain a reaction product solution containing a reaction product (H). Analysis of infrared absorption spectrum of the resultant reaction product solution confirmed disappearance of absorption of isocyanate group. A product obtained by distilling off ethyl acetate from the reaction product solution had a softening temperature of 85° C.

Synthesis of Reaction Product (I)

122.9 g of ethyl acetate and 169.9 g of isophoronediisocyanate trimer [VESTANAT T1890] were charged in a reactor, and the temperature within the system was raised to 80° C. to dissolve. After bubbling air into the solution, 0.20 g of hydroquinone monomethyl ether, 95.9 g of hydroxybutyl acrylate, 21.0 g of polyethylene glycol [PEG#300] and 0.20 g of dibutyltin dilaurate were charged therein. After conducting the reaction at 80° C. for 5 hours, 547.3 g of ethyl acetate was added thereto to cool the reaction mixture and obtain a reaction product solution containing a reaction product (I). Analysis of infrared absorption spectrum of the resultant reaction product solution confirmed disappearance of absorption of isocyanate group. A product obtained by distilling off ethyl acetate from the reaction product solution had a softening temperature of 54° C.

Synthesis of Reaction Product (J)

144.1 g of ethyl acetate and 169.9 g of isophoronediisocyanate trimer [VESTANAT T1890] were charged in a reactor, and the temperature within the system was raised to 80° C. to dissolve. After bubbling air into the solution, 0.20 g of hydroquinone monomethyl ether, 90.6 g of pentaerythritol acrylate [Viscoat 300], 75.7 g of hydroxybutyl acrylate, and 0.20 g of dibutyltin dilaurate were charged therein. After conducting the reaction at 80° C. for 5 hours, 641.6 g of ethyl acetate was added thereto to cool the reaction mixture and obtain a reaction product solution containing a reaction product (J). Analysis of infrared absorption spectrum of the resultant reaction product solution confirmed disappearance of absorption of isocyanate group. A product obtained by distilling off ethyl acetate from the reaction product solution had a softening temperature of 63° C.

### Examples 1 to 7

100 parts by weight of each of the reaction product solutions obtained in synthesis of the reaction products (A) to (G) (content of solids: 30% by weight) was mixed with 3 parts by weight per 100 parts by weight of the reaction product solution excluding the solvent (i.e., 0.9 part by weight per 100 parts by weight of the solution) of a photopolymerization initiator [Irgacure 184:1-hydroxycyclohexyl phenyl ketone (made by CIBA GEIGY)] to prepare an active energy ray-curable composition.

Additionally, since the reaction product (F) does not contain the solvent, 30 parts by weight of the reaction product was used in Example 6.

Each of the active energy ray-curable compositions was used as a coating solution and coated on a 2-mm thick polypropylene sheet [Mitsubishi Noblen MA3U (made by Nippon Polychem K. K.) in a dry thickness of 5 μm using a bar coater, followed by drying at 80° C. for 2 minutes. This was irradiated with UV rays at 600 mJ/cm² using a high-pressure mercury lamp of 120 W/cm in output to cure the composition.

Evaluation was conducted on coating properties of each of the coating solutions and on adhesion of each of the cured coats. Results thus obtained are shown in Table 1.

Additionally, coating properties and adhesion were evaluated according to the following methods.

Coating properties: The cured coats were evaluated visually.

A: The coat was uniformly coated.

B: Cissing was observed in part of the coat.

C: Cissing was observed all over the coat (the coat being in a granular state).

Adhesion: Crosscuts were formed longitudinally and transversely in the cured coat so that the cutter reached the substrate surface, with 1-mm intervals, to form 100 crosscut pieces of 1 mm² in area. A cellophane tape was adhered thereto, then rapidely peeled off to count peeled-off crosscut pieces.

A: No piece was peeled off.

B: 1 to 50 pieces were peeled off.

C: 51 to 100 pieces were peeled off.

Comparative Examples 1 to 7

Coating on a polypropylene sheet and curing by irradiation with UV rays were conducted in the same manner as in Example 1 except for using, in place of the reaction product solution, a solution prepared by dissolving one of varying commercially available products having an acryloyl group in ethyl acetate in a concentration of 30% by weight and shown in Table 1. However, adhesion was not evaluated because all of them showed poor coating properties. Results on the coating properties are tabulated in Table 1.

TABLE 1

| | Active energy | Coating | Adhe- |
|---|---|---|---|
| | ray-curable Compound | Properties | sion |
| Ex. 1 | Reaction product (A) | A | A |
| Ex. 2 | Reaction product (B) | A | B |
| Ex. 3 | Reaction product (C) | A | B |
| Ex. 4 | Reaction product (D) | A | B |
| Ex. 5 | Reaction product (E) | A | B |
| Ex. 6 | Reaction product (F) | A | A |
| Ex. 7 | Reaction product (G) | A | A |
| Com. Ex. 1 | Pentaerythritol | C | — |
| | triacrylate *1 | | |
| Com. Ex. 2 | Dipentaerythritol | C | — |
| | hexaacrylate *2 | | |
| Com. Ex. 3 | Dicyclopentenyl | C | — |
| | acrylate *3 | | |
| Com. Ex. 4 | Tricyclodecanyl | C | — |
| | acrylate *4 | | |
| Com. Ex. 5 | Dimethyloltricyclodecane | C | — |
| | acrylate *5 | | |
| Com. Ex. 6 | Pentaerythritol | C | — |
| | triacrylate · hexamethylene- | | |
| | diisocyanate adduct *6 | | |
| Com. Ex. 7 | Pentaerythritol | C | — |
| | triacrylate · tolylenediiso- | | |
| | cyanate adduct *7 | | |

*1: pentaerythritol triacrylate: Viscoat 300 (made by Osaka Organic Chemical Industry Co., Ltd.)
*2: dipentaerythritol hexaacrylate: Kayarad DPHA (made by Nippon Kayaku Co., Ltd.)
*3: dicyclopentenyl acrylate: Fancryl FA-512A (made by Hitachi Chemical Co., Ltd.)
*4: tricyclodecanyl acrylate: Fancryl FA-513A (made by Hitachi Chemical Co., Ltd.)
*5: dimethyloltricyclodecane diacrylate: Yupimer UV SA-1002 (made by Mitsubishi Chemical Corporation)
*6: pentaerythritol triacrylate.hexamethylenediiso-cyanate adduct: urethane acrylate UA-306H (Kyoeisha Kagaku K. K.)
*7: pentaerythritol triacrylate tolylenediisocyanate adduct: urethane acrylate UA-306T (Kyoeisha Kagaku K. K.)

### Examples 8 to 13

The reaction product solution obtained in synthesis of the reaction product (A) was mixed with a filming resin in a proportion shown in Table 2, followed by adding thereto ethyl acetate to make the total amount 100 parts by weight. Thus, there were prepared solutions having solid component concentrations of 30% by weight. To each of the solutions was added 3 parts by weight per 100 parts by weight of the reaction product solution excluding the solvent (i.e., 0.9 part by weight per 100 parts by weight of the solution) of a photopolymerization initiator [Irgacure 184 (made by CIBA GEIGY)] to prepare active energy ray-curable compositions.

Additionally, in Example 12, a product obtained by removing the solvent from the reaction product solution was used in place of the reaction product solution, and toluene was used as the solvent to be added.

Coating properties of the coating solution onto a polypropylene sheet and adhesion of the resultant cured coat were evaluated in the same manner as in Example 1 except for using the active energy ray-curable compositions as the coating solution. Results thus obtained are shown in Table 2.

TABLE 2

| | Reaction | | | | |
|---|---|---|---|---|---|
| | Product | | | | |
| | (A) | Filming Resin | | | |
| | parts by | | Parts | Coating | |
| | weight | | by | Prop- | Adhe- |
| | (*1) | Kind | weight | erties | sion |
| Ex. 8 | 24 (80) | Methacrylic | 6 | A | A |
| | | resin *8 | | | |
| Ex. 9 | 24 (80) | Epoxy resin *9 | 6 | A | A |
| Ex. 10 | 24 (80) | Urethane | 6 | A | A |
| | | resin *10 | | | |
| Ex. 11 | 24 (80) | Polyester | 6 | A | A |
| | | resin *11 | | | |
| Ex. 12 | 24 | Chlorinated | 6 | A | A |
| | | polypropylene *12 | | | |
| Ex. 13 | 3 (10) | Methacrylic | 27 | A | A |
| | | resin *8 | | | |

*1: numerals represent parts by weight of solid components, and numerals within parentheses represent parts by weight of the reaction product solution.
*8: methacrylic resin: Parapet GF (product of Kuraray Co., Ltd.)
*9: epoxy resin: Epicoat 1004 (product of Yuka Shell Epoxy Co.)
*10: urethane resin: Pandex T-5201 (product of Dainippon Ink and Chemicals, Incorporated)
*11: polyester resin: Biron 200 (product of Toyobo K. K.)
*12: chlorinated polypropylene: Superclon 822S (product of Nippon Seishi K. K.)

### Examples 14 to 19

24 parts by weight of the reaction product between the isocyanate compound and the (meth)acryl compound (80 parts by weight of the reaction product solution with respect to the reaction products (B) to (G)) was mixed with 6 parts by weight of a filming resin (Parapet GF made by Kuraray Co., Ltd.), followed by adding thereto ethyl acetate to make the total amount 100 parts by weight. Thus, there were prepared solutions having solid component concentrations of 30% by weight. To each of the solutions was added 3 parts by weight per 100 parts by weight of the reaction product solution excluding the solvent (i.e., 0.9 part by weight per 100 parts by weight of the solution) of a photopolymerization initiator [Irgacure 184 (made by CIBA GEIGY)] to prepare active energy ray-curable compositions. Coating properties of the coating solution onto a polypropylene sheet and adhesion of the resultant cured coat were evaluated in the same manner as in Example 1 except for using the active energy ray-curable compositions as the coating solutions. Results thus obtained are shown in Table 3.

TABLE 3

| | | Coating | |
|---|---|---|---|
| | Reaction Product | Properties | Adhesion |
| Ex. 14 | pentaerythritol triacrylate. | A | A |
| | isophoronediisocyanate | | |
| | adduct *13 | | |
| Ex. 15 | Reaction product (B) | A | A |
| Ex. 16 | Reaction product (C) | A | A |
| Ex. 17 | Reaction product (D) | A | A |
| Ex. 18 | Reaction product (E) | A | A |
| Ex. 19 | Reaction product (G) | A | A |

*13: pentaerythritol triacrylate.isophoronediisocyanate adduct: urethane acrylate UA-306I (product of Kyoeisha Kagaku K. K.)

### Examples 20 to 25

Each of the reaction product solutions obtained above respectively containing the reaction products (A), (C), (G) to (J) (content of solids: 30% by weight) was mixed with 3 parts by weight per 100 parts by weight of the reaction product solution excluding the solvent (i.e., 0.9 part by weight per 100 parts by weight of the solution) of a photopolymerization initiator [Irgacure 184:1-hydroxycyclohexyl phenyl ketone (made by CIBA GEIGY)] to prepare active energy ray-curable compositions.

Each of the active energy ray-curable compositions was used as a coating solution and coated on a polyester film and cold-rolled steel sheet in a dry thickness of 5 μm using a bar coater, followed by drying at 80° C. for 2 minutes. Subsequently, each of them was irradiated with UV rays in a dose of 600 mJ/ cm² using a high-pressure mercury lamp of 120 W/cm in output spaced at a distance of 15 cm to cure the composition.

The thus formed coats before curing were subjected to evaluation on non-tack properties, and the cured coats were subjected to evaluation on adhesion, haze and pencil hardness. Results thus obtained are shown in Table 4. Additionally, non-tack properties, adhesion, haze and pencil hardness were evaluated according to the following methods.

Non-tack properties:

A coat on a polyester film was dried, then the surface was touched with a finger to check for tack. Samples showing no traces of finger touch were evaluated as tack-free, and samples showing the trace of finger touch as tacky.

Adhesion:

Crosscuts were formed in the cured coat on the polyester film or on the steel sheet so that the cutter reached the substrate surface, with 1-mm intervals, to form 100 crosscut pieces of 1 mm² in area. A cellophane tape was adhered thereto, then rapidly peeled off. Peeling-off by adhesion with the cellophane tape was observed, and samples undergoing peeling-off were evaluated as “peeled-off”, and samples undergoing no peeling-off as “non-peeled-off”

Haze:

Haze was measured with respect to a cured coat on the polyester film using a haze meter.

Pencil hardness:

Pencil hardness was measured according to the pencil-scratching test of JIS K5400.

Comparative Example 8

The same procedures as in Example 20 were conducted except for using pentaerythritol triacrylate [Viscoat 300 (made by Osaka Organic Chemical Industry Co., Ltd.) in place of the reaction product solution. Results are shown in Table 4.

Reference Example 1

The same procedures as in Example 20 were conducted except for using an adduct between pentaerythritol triacrylate and isophoronediisocyanate (Mp: −60° C.) [urethane acrylate UA-3061 (product of Kyoeisha Kagaku K. K.); softening point: 25° C. or lower] in place of the reaction product solution. Results are shown in Table 4.

TABLE 4

| | Active | | | | |
|---|---|---|---|---|---|
| | Energy Ray- | Results of Evaluation | | | |
| | Curable | Non-tack | | Haze | Hard- |
| | component | Properties | Adhesion | (%) | ness |
| Ex. 20 | Reaction | tack-free | non-peeled- | 1.4 | 4H |
| | product (A) | | off | | |
| Ex. 21 | Reaction | tack-free | non-peeled- | 1.2 | 4H |
| | product (C) | | off | | |
| Ex. 22 | Reaction | tack-free | non-peeled- | 1.3 | 3H |
| | product (G) | | off | | |
| Ex. 23 | Reaction | tack-free | non-peeled- | 1.4 | 4H |
| | product (H) | | off | | |
| Ex. 24 | Reaction | tack-free | non-peeled- | 1.4 | H |
| | product (I) | | off | | |
| Ex. 25 | Reaction | tack-free | non-peeled- | 1.3 | 4H |
| | product (J) | | off | | |
| Com. | Penta- | tacky | — | — | — |
| Ex. 80 | erythritol | | | | |
| | triacrylate | | | | |
| Ref. | Penta- | | | | |
| Ex. 1 | erythritol | | | | |
| | triacrylate. | | | | |
| | isophorone- | tacky | — | — | — |
| | diiso- | | | | |
| | cyanate | | | | |
| | adduct *13 | | | | |

### Examples 26 to 31

The reaction product solution obtained in synthesis of the reaction product (A) was mixed with a filming resin in a proportion shown in Table 5, followed by adding thereto 70 parts by weight of ethyl acetate to make the total amount 100 parts by weight. To each of the solutions was added 3 parts by weight per 100 parts by weight of the reaction product solution excluding the solvent (i.e., 0.9 part by weight per 100 parts by weight of the solution) of a photopolymerization initiator [Irgacure 184 (made by CIBA GEIGY)] to prepare active energy ray-curable compositions. Non-tack properties were evaluated with respect to coats before curing, and adhesion was evaluated with respect to cured coats. Results are shown in Table 5.

TABLE 5

| | Reaction | | | | |
|---|---|---|---|---|---|
| | Product | | | | |
| | (A) | Filming Resin | | Non- | |
| | parts by | | Parts | tack | |
| | weight | | by | Prop- | Adhe- |
| | (*2) | Kind | weight | erties | sion |
| Ex. 26 | 24 | Methacrylic | 6 | tack- | non- |
| | | resin *8 | | free | peeled- |
| | | | | | off |
| Ex. 27 | 24 | Epoxy | 6 | tack- | non- |
| | | resin *9 | | free | peeled- |
| | | | | | off |
| Ex. 28 | 24 | Urethane | 6 | tack- | non- |
| | | resin *10 | | free | peeled- |
| | | | | | off |
| Ex. 29 | 24 | Polyester | 6 | tack- | non- |
| | | resin *11 | | free | peeled- |
| | | | | | off |
| Ex. 30 | 3 | Methacrylic | 27 | tack- | non- |
| | | resin *8 | | free | peeled- |
| | | | | | off |
| Ex. 31 | 1.5 | Methacrylic | 28.5 | tack- | peeled- |
| | | resin *8 | | free | off |

*2: numerals represent parts by weight of solid components

Industrial Applicability

The invention enables to form a coat on polyolefin with a good adhesion, and provides a tack-free coat.

1. A laminate comprising a polyolefin substrate having formed thereon a layer comprising an active energy ray-curable composition which comprises a reaction product between an isocyanate compound having an isocyanate group bound to a non-aromatic hydrocarbon ring and a (meth)acryl compound having a (meth)acryloyl group and being capable of reacting with the isocyanate group.

2. The laminate as defined in claim 1, wherein the isocyanate compound is an isocyanate compound having a melting point of 40° C. or higher.

3. The laminate as defined in claim 1 or 2, wherein the isocyanate compound is isophoronediisocyanate, isophoronediisocyanate trimer, a reaction product between isophoronediisocyanate and an active hydrogen-containing compound, or a reaction product between isophoronediisocyanate trimer and an active hydrogen-containing compound.

4. The laminate as defined in any one of claims 1 to 3, wherein the (meth)acryl compound is (meth)acrylic acid.

5. The laminate as defined in any one of claims 1 to 3, wherein the (meth)acryl compound is hydroxyl group-containing (meth)acrylate.

6. The laminate as defined in any one of claims 1 to 5, wherein the reaction product between the isocyanate compound and the (meth)acryl compound has a softening point of 40° C. or higher.

7. The laminate as defined in any one of claims 1 to 6, wherein the active energy ray-curable composition contains a filming resin.

8. A method of adhering polyolefin, which comprises using an active energy ray-curable composition which comprises a reaction product between an isocyanate compound having an isocyanate group bound to a non-aromatic hydrocarbon ring and a (meth)acryl compound having a (meth)acryloyl group and being capable of reacting with the isocyanate group.

9. The adhering method as defined in claim 8, wherein the isocyanate compound is an isocyanate compound having a melting point of 40° C. or higher.

10. The adhering method as defined in claim 8 or 9, wherein the isocyanate compound is isophoronediisocyanate, isophoronediisocyanate trimer, a reaction product between isophoronediisocyanate and an active hydrogen-containing compound, or a reaction product between isophoronediisocyanate trimer and an active hydrogen-containing compound.

11. The adhering method as defined in any one of claims 8 to 10, wherein the (meth)acryl compound is (meth)acrylic acid.

12. The adhering method as defined in any one of claims 8 to 10, wherein the (meth)acryl compound is hydroxyl group-containing (meth)acrylate.

13. The adhering method as defined in any one of claims 8 to 12, wherein the reaction product between the isocyanate compound and the (meth)acryl compound has a softening point of 40° C. or higher.

14. The adhering method as defined in any one of claims 8 to 13, wherein the active energy ray-curable composition contains a filming resin.

15. A process for producing a substrate with a coat, which comprises forming on the substrate a coat layer comprising an active energy ray-curable composition comprising a reaction product between an isocyanate compound having a melting point of 40° C. or higher and a (meth)acryl compound having a (meth)acryloyl group and being capable of reacting with the isocyanate group, which product has a softening point of 40° C. or higher, conducting fabrication, then curing the active energy ray-curable composition.

16. A laminate comprising a substrate having formed thereon a layer comprising an active energy ray-curable composition comprising a reaction product between an isocyanate compound having a melting point of 40° C. or higher and a (meth)acryl compound having a (meth)acryloyl group and being capable of reacting with the isocyanate group, which product has a softening point of 40° C. or higher.

17. An active energy ray-curable composition, which comprises a reaction product between an isocyanate compound having an isocyanate group bound to a non-aromatic hydrocarbon ring and a (meth)acryl compound having a (meth)acryloyl group and being capable of reacting with the isocyanate group.

18. The active energy ray-curable composition as defined in claim 17, wherein the isocyanate compound is an isocyanate compound having a melting point of 40° C. or higher.

19. The active energy ray-curable composition as defined in claim 17 or 18, wherein the isocyanate compound is isophoronediisocyanate trimer, a reaction product between isophoronediisocyanate and an active hydrogen-containing compound, or a reaction product between isophoronediisocyanate trimer and an active hydrogen-containing compound.

20. The active energy ray-curable composition as defined in any one of claims 17 to 19, wherein the (meth)acryl compound is (meth)acrylic acid.

21. The active energy ray-curable composition as defined in any one of claims 17 to 20, wherein the (meth)acryl compound is hydroxyl group-containing (meth)acrylate.

22. The active energy ray-curable composition as defined in any one of claims 17 to 21, wherein the reaction product between the isocyanate compound and the (meth)acryl compound has a softening point of 40° C. or higher.

23. The active energy ray-curable composition as defined in any one of claims 17 to 22, wherein the active energy ray-curable composition contains a filming resin.
